(19) United States
(12) Patent Application Publication
(10) Pub. No.: US 2017/0053109 A1
(43) Pub. Date: Feb. 23, 2017

(54) MOBILE TERMINAL AND METHOD FOR CONTROLLING THE SAME

(71) Applicant: LG ELECTRONICS INC., Seoul (KR)

(72) Inventors: Jongwoo HAN, Seoul (KR); Ilyong LEE, Seoul (KR)

(73) Assignee: LG ELECTRONICS INC., Seoul (KR)

(21) Appl. No.: 14/949,409

(22) Filed: Nov. 23, 2015

(30) Foreign Application Priority Data
Aug. 17, 2015 (KR) 10-2015-0115651

(51) Int. Cl. G06F 21/32; G06K 9/00

(52) U.S. Cl. CPC G06F 21/32; G06K 9/00228; G06K 9/00268; G06K 9/00288

(57) ABSTRACT

Disclosed are a mobile terminal and a method for controlling the same. A mobile terminal capable of performing a face recognition function includes a display unit, a camera for photographing a face image, and a controller for changing a locking state in which the execution of a function of the mobile terminal is limited to an unlocking state in which the execution of the function of the mobile is possible, based on that a face movement extracted from the face image photographed through the camera satisfies a predetermined condition. The controller displays, on the display unit, a graphic object related to a previously stored face movement. When the face movement extracted from the face image photographed through the camera corresponds to the previously stored face movement, the controller changes the locking state to the unlocking state.

### CROSS-REFERENCE TO RELATED APPLICATIONS

Pursuant to 35 U.S.C. §119(a), this application claims the benefit of earlier filing date and right of priority to Korean Application No. 10-2015-0115651, filed on Aug. 17, 2015, the contents of which is incorporated by reference herein in its entirety.

### BACKGROUND OF THE DISCLOSURE

1. Field of the Disclosure

The present disclosure relates to a mobile terminal capable of performing a face recognition and a method for controlling the same.

2. Description of the Conventional Art

In general, a terminal may be classified into a mobile (portable) terminal and a stationary terminal according to a moveable state. The mobile terminal may be also classified into a handheld terminal and a vehicle mount terminal according to a user's carriage method.

As functions of the terminal become more diversified, the terminal can support more complicated functions such as capturing images or video, reproducing music or video files, playing games, receiving broadcast signals, and the like. By comprehensively and collectively implementing such functions, the mobile terminal may be embodied in the form of a multimedia player or a device.

Various attempts have been made to implement complicated functions in such a multimedia device by means of hardware or software.

Various authentication methods for authenticating a user of a terminal have recently been developed for the purpose of security of personalized terminals. For example, the authentication of a user may be performed by an authentication method using biometric information. The biometric information may include face image information, fingerprint information, iris information, PPG information, and the like.

Meanwhile, for the user authentication, when an illegal user forges authentication information of a user and attempts a user authentication by using the forged authentication information, the security of the user authentication is weakened. For example, a user may generate a fake face by using a face image of the user, and attempt a user authentication through the fake face.

Accordingly, in order to solve the weakness of the security, the present disclosure proposes a technique for determining whether user's biometric information is forged.

### SUMMARY OF THE DISCLOSURE

Therefore, an aspect of the detailed description is to provide a mobile terminal and a method for controlling the same, which can enhance security when a user authentication is performed through a user's face image.

Another aspect of the detailed description is to provide a mobile terminal and a method for controlling the same, which can increase the detection accuracy of a fake face.

To achieve these and other advantages and in accordance with the purpose of this specification, as embodied and broadly described herein, a mobile terminal capable of performing a face recognition function includes: a display unit; a camera configured to photograph a face image; and a controller configured to change a locking state in which the execution of a function of the mobile terminal is limited to an unlocking state in which the execution of the function of the mobile is possible, based on that a face movement extracted from the face image photographed through the camera satisfies a predetermined condition, wherein the controller displays, on the display unit, a graphic object related to a previously stored face movement, and wherein, when the face movement extracted from the face image photographed through the camera corresponds to the previously stored face movement, the controller changes the locking state to the unlocking state.

In one exemplary embodiment, the face movement extracted from the photographed face image may be at least one of a movement of a sight and a movement of a mouth.

In one exemplary embodiment, the movement of the sight may be a movement based on at least one of a moving speed of the sight and a sight direction.

In one exemplary embodiment, when the extracted face movement does not correspond to the previously stored face movement, the controller may decide that the face image corresponds to a fake face.

In one exemplary embodiment, the graphic object related to the previously stored face movement may be a specific word. The controller may detect a movement of the mouth in the photographed face image, and change the locking state to the unlocking state, when the extracted movement of the mouth is a movement of the mouth corresponding to the specific word.

In one exemplary embodiment, the specific word may be displayed at a specific position on the display unit. The controller may detect a sight direction in the photographed face image, and change the locking state to the unlocking state, when the sight faces a specific area in which the specific word is displayed, based on the sight direction.

In one exemplary embodiment, when the at least one of the movement of the sight and the movement of the mouth does not correspond to a predetermined movement, the controller may maintain the locking state.

In one exemplary embodiment, the controller may arbitrarily set the specific position at which the specific word is displayed.

In one exemplary embodiment, when the sight extracted from the photographed face image moves to face the graphic object within a predetermined time from a point of time when the graphic object is displayed, the controller may change the locking state to the unlocking state.

In one exemplary embodiment, the graphic object related to the previously stored face movement may be a graphic object moving while forming a predetermined pattern. The controller may detect a movement of the sight in the photographed face image, and change the locking state to the unlocking state, when a pattern formed based on the movement of the sight corresponds to the predetermined pattern.

In one exemplary embodiment, when the pattern formed by the movement of the sight does not correspond to the predetermined pattern, the controller may maintain the locking state.

In one exemplary embodiment, when the movement of the photographed face image does not satisfy the predetermined condition, the controller may maintain the locking state, and display, on the display unit, notification information for notifying that the locking state is not released.

In one exemplary embodiment, when the mobile terminal is in the locking state, the controller may display, on the display unit, a lock screen indicating the locking state. The graphic object related to the previously stored face movement may be displayed on the lock screen.

In one exemplary embodiment, when the lock screen is displayed, the controller may arbitrarily set the position at which the graphic object related to the previously stored face movement is displayed on the lock screen.

In one exemplary embodiment, when the photographed face image does not correspond to a previously stored face image, the controller may maintain the locking state even though a face movement extracted from the previously stored face image corresponds to the previously stored face movement.

To achieve these and other advantages and in accordance with the purpose of this specification, as embodied and broadly described herein, a method for controlling a mobile terminal capable of performing a face recognition function includes: displaying, on a display unit, a graphic object related to a previously stored face movement; photographing a face image through a camera; deciding whether a face movement extracted from the photographed face image corresponds to the previously stored face movement; and when it is decided that the photographed face image corresponds to the previously stored face movement, changing a locking state in which the execution of a function of the mobile terminal is limited to an unlocking state in which the execution of the function of the mobile is possible.

In one exemplary embodiment, the previously stored face movement may be at least one of a movement of a sight included in the face image and a movement of a mouth included in the face image.

In one exemplary embodiment, the graphic object related to the previously stored face movement may be displayed at an arbitrary position on a lock screen indicating the locking state.

Further scope of applicability of the present application will become more apparent from the detailed description given hereinafter. However, it should be understood that the detailed description and specific examples, while indicating preferred embodiments of the disclosure, are given by way of illustration only, since various changes and modifications within the spirit and scope of the disclosure will become apparent to those skilled in the art from the detailed description.

### BRIEF DESCRIPTION OF THE DRAWING

The accompanying drawings, which are included to provide a further understanding of the disclosure and are incorporated in and constitute a part of this specification, illustrate exemplary embodiments and together with the description serve to explain the principles of the disclosure.

In the drawings:

FIG. 1A is a block diagram illustrating a mobile terminal according to an exemplary embodiment;

FIGS. 1B and 1C are conceptual views illustrating an example of the mobile terminal, viewed in different directions according to the exemplary embodiment;

FIG. 2 is a flowchart illustrating a control method of performing a user authentication through a face recognition in the mobile terminal according to the exemplary embodiment;

FIGS. 3A, 3B, and 3C are conceptual views illustrating the control method of FIG. 2; and

FIGS. 4A to 7 are conceptual views illustrating a control method of performing a user authentication through a face movement.

### DETAILED DESCRIPTION OF EXEMPLARY EMBODIMENTS

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

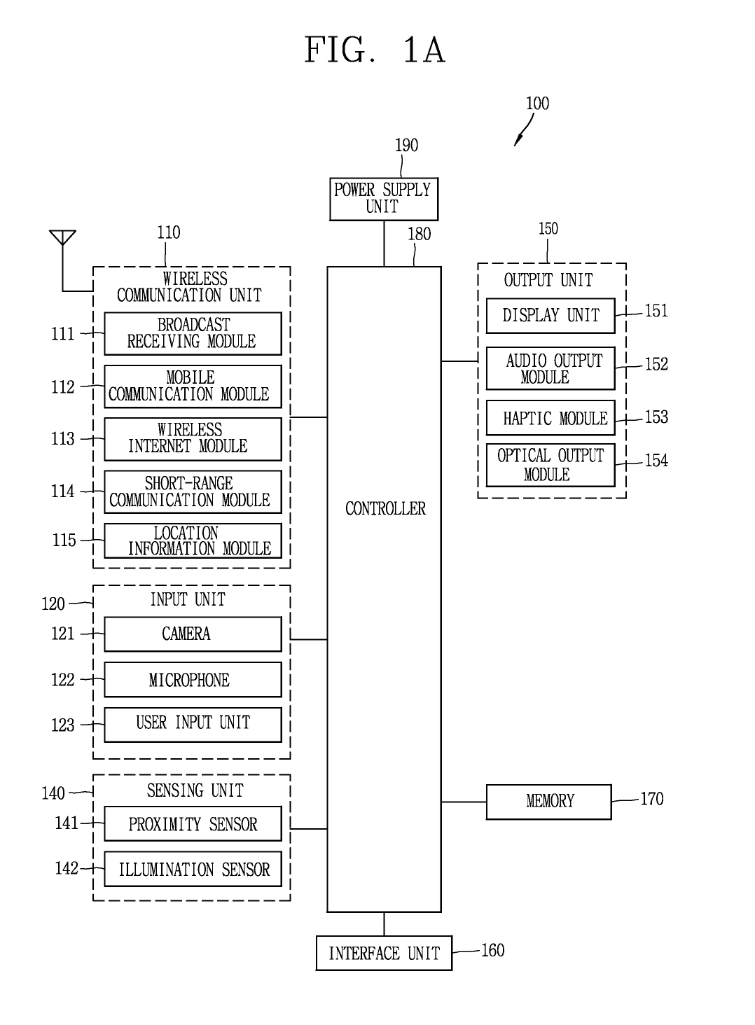

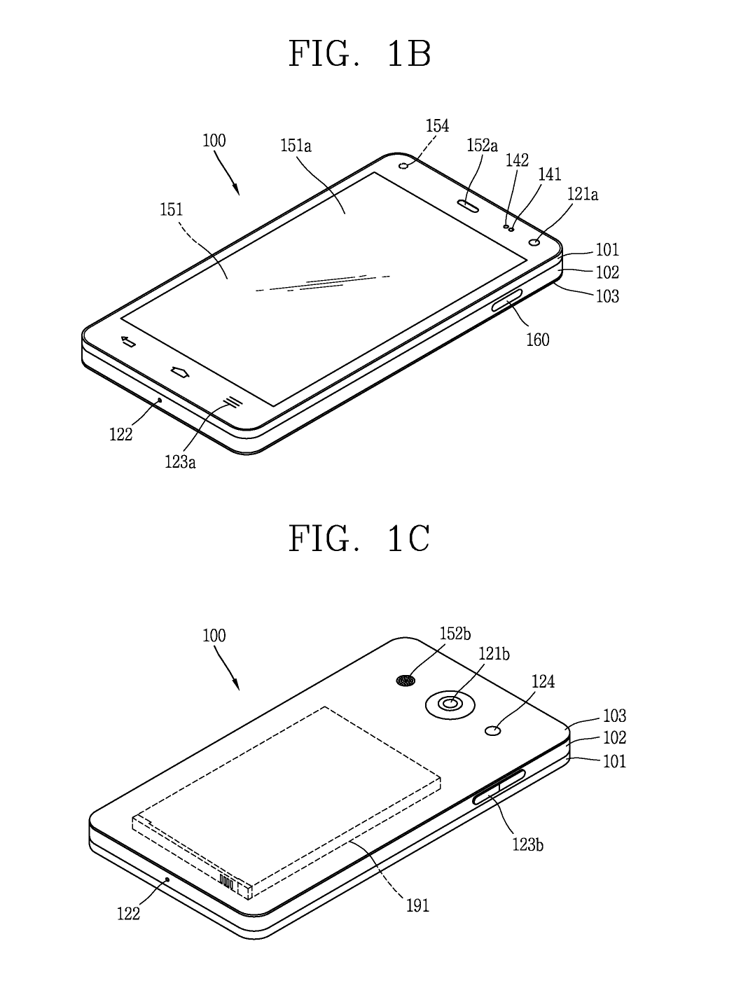

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

Referring now to FIG. 1A, the mobile terminal 100 is shown having wireless communication unit 110 configured with several commonly implemented components. For instance, the wireless communication unit 110 typically includes one or more components which permit wireless communication between the mobile terminal 100 and a wireless communication system or network within which the mobile terminal is located.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks. To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1A, the sensing unit 140 is shown having a proximity sensor 141 and an illumination sensor 142.

If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154.

The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output by the various components depicted in FIG. 1A, or activating application programs stored in the memory 170. As one example, the controller 180 controls some or all of the components illustrated in FIGS. 1A-1C according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the body, or configured to be detachable from the body.

At least some of the above components may operate in a cooperating manner, so as to implement an operation or a control method of a glass type terminal according to various embodiments to be explained later. The operation or the control method of the glass type terminal may be implemented on the glass type terminal by driving at least one application program stored in the memory 170.

Referring still to FIG. 1A, various components depicted in this figure will now be described in more detail.

Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like). Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal.

As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images. A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner. Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Description will now be given in detail of the exemplary embodiments, with reference to the accompanying drawings. For the sake of brief description with reference to the drawings, the same or equivalent components will be provided with the same reference numbers, and description thereof will not be repeated. In the following description of drawings, drawings will be described in a clockwise order or an order from the top to the bottom, based on a drawing shown at the left top.

First, the mobile terminal according to the exemplary embodiment, as described above, may include a cellular phone, a smart phone, a laptop computer, a digital broadcasting terminal, a personal digital assistant (PDA), a portable multimedia player (PMP), a navigation, a slate PC, a tablet PC, an ultra book, a wearable device (e.g., a smart watch, a smart glass or a head mounted display (HMD)), and the like.

In the following description, a case where the mobile terminal is a laptop computer will be described as an example. However, the present disclosure is not limited thereto, and may be applied to all mobile terminals such as a cellular phone, which can perform a face recognition.

Meanwhile, in the mobile terminal according to the exemplary embodiment, a locking state of the mobile terminal may be changed to an unlocking state of the mobile terminal through a user authentication.

The user authentication may mean a process in which an owner of the mobile terminal changes the locking state of the mobile terminal to the unlocking state of the mobile terminal. Conventionally, a password, a user authentication through a pattern input, or a user authentication through recognition of user's biometric information (e.g., heart rate information, iris recognition information, fingerprint information, face image information, etc.) was used as the user authentication. Also, the user authentication may be understood as the same meaning as the term “log-in,” “locking release,” etc.

As an example of the user authentication, a face recognition function is a method of extracting a user's face image and deciding whether positions and shapes of eyes, a nose, a mouth, ears, etc., included in the user's face image, correspond to previously stored face information. For example, in the face recognition function, a user authentication may be performed by extracting features of a user's face, using a user's face image, and comparing the extracted features with previously stored face information. The face recognition function may include all details apparent to those skilled in the art.

The face recognition function has a weakness in that a user authentication may be performed through a fake face such as a face picture. Various methods have been developed so as to overcome this weakness.

According to the present disclosure, in order to prevent a user authentication from being performed through a fake face, it is determined whether a face movement corresponds to a previously stored face movement together with whether the face image corresponds to the previously stored face information in the face recognition function. The following face recognition function may be understood as a function of simultaneously deciding a face image and a face movement.

The locking state may mean a state in which the execution of at least one application among applications installed in the mobile terminal is limited. Here, the application may mean an application program installed in the mobile terminal. Alternatively, the locking state may mean a state in which the execution of at least one function provided by an application is limited during execution of the application. Alternatively, the locking state may mean a state in which the execution of a specific function provided in a website is limited.

Thus, when the mobile terminal is in the locking state, the user cannot use at least one application installed in the mobile terminal or at least one function provided by the application.

The unlocking state may mean a state in which the execution of applications installed in the mobile terminal is possible based on a user's request. Alternatively, the unlocking state may mean a state in which the execution of a function of which execution was limited is possible during execution of an application. Alternatively, the unlocking state may mean a state in which the execution of a specific function provided in a website is limited.

Thus, when the mobile terminal is in the unlocking state, the user may execute an application through a control command or execute functions of which execution was limited.

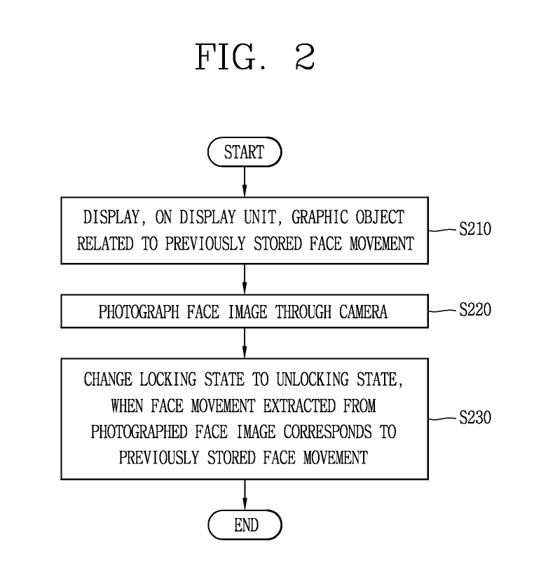

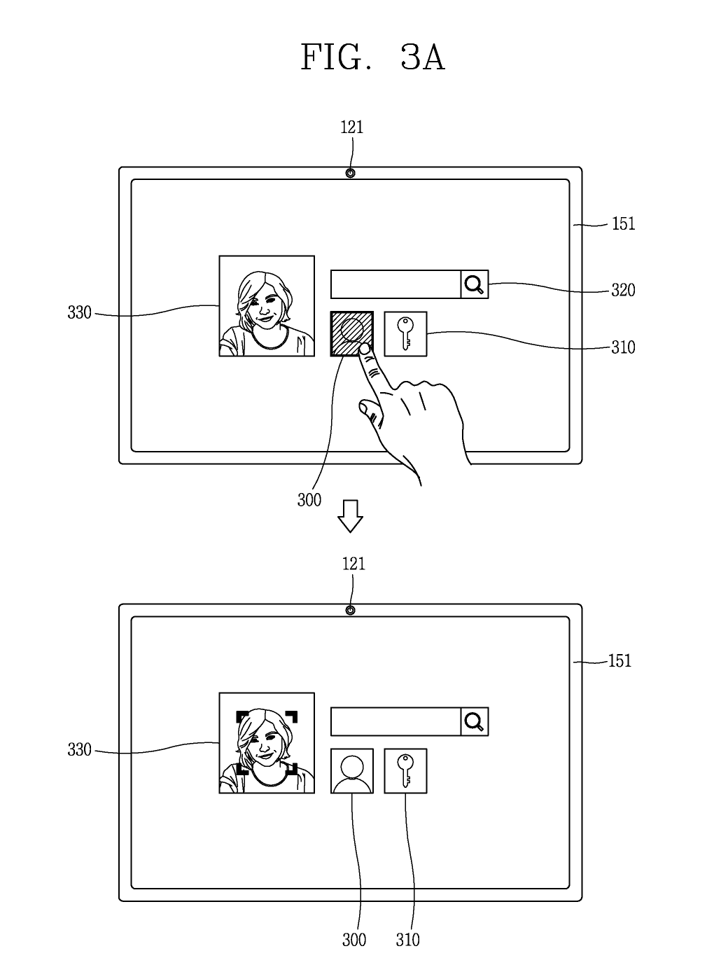

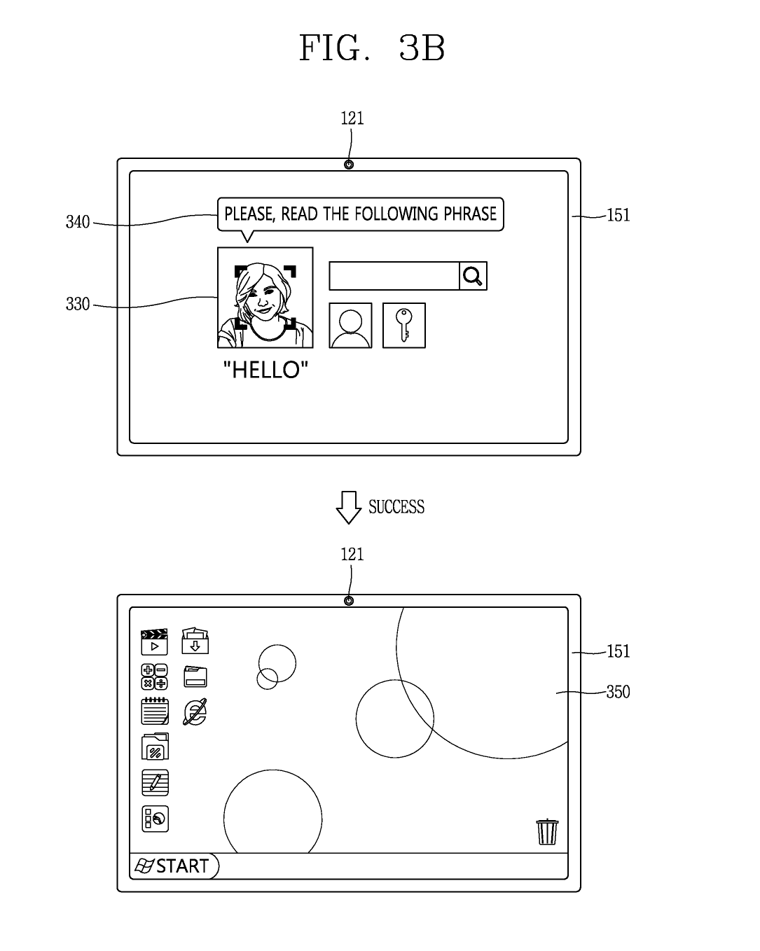

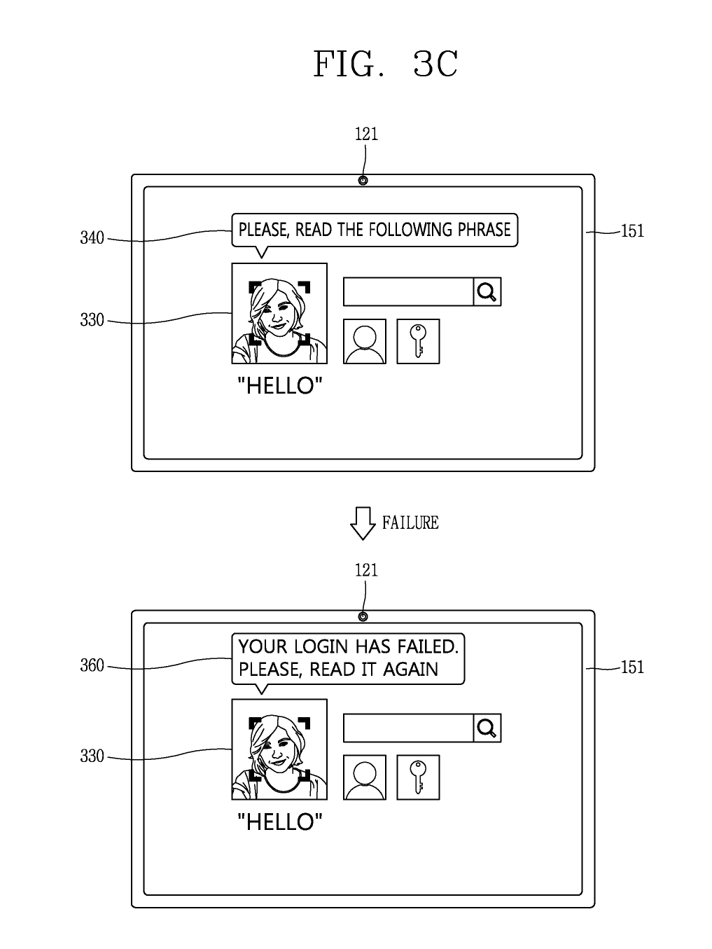

Hereinafter, a control method of performing a user authentication through a face recognition will be described in detail with reference to the accompanying drawings. FIG. 2 is a flowchart illustrating a control method of performing a user authentication through a face recognition in the mobile terminal according to the exemplary embodiment. FIGS. 3A, 3B, and 3C are conceptual views illustrating the control method of FIG. 2.

First, the mobile terminal according to the exemplary embodiment may display, on the display unit, a graphic object related to a previously stored face movement, so as to perform a user authentication (S210).

The mobile terminal according to the exemplary embodiment may enter into any one of a locking state and an unlocking state.

The mobile terminal may enter into the locking state, based on a predetermined condition. For example, when a control command for turning on the power of the mobile terminal is applied, when a control command for again tuning on display unit 151 of the mobile terminal is applied in a state in which the display unit 151 is turned off, when the mobile terminal does not receive a control command from a user for a predetermined time, or when a face recognized through the camera does not correspond to a predetermined face, the mobile terminal may enter into the locking state.

When the mobile terminal is in the locking state, the controller 180 may perform a user authentication.

The controller 180 may provide various methods as a user authentication method. In this case, the user authentication method may be set by the user of the mobile terminal or previously set when the mobile terminal is delivered from a factory. For example, as shown in a first drawing of FIG. 3A, the controller 180 may set the user authentication method as a face recognition method, in response to that a touch is applied to a graphic object 300 related to a face recognition function on a lock screen.

Also, the controller 180 may display, on the display unit 151, the lock screen indicating the locking state.

A background image in the locking state and graphic objects (or unlocking objects) for releasing the locking state may be included in the locking screen. For example, as shown in the first drawing of FIG. 3A, the graphic objects for releasing the locking state may include the graphic object 300 related to the face recognition function, a graphic object 310 related to a password input function, a password input window 320, and a graphic object for displaying user information.

More specifically, when the user authentication method is set as face recognition, the controller 180 may display screen information for the face recognition on the lock screen. The screen information for the face recognition may include a graphic object related to a previously stored face movement. For example, as shown in a first drawing of FIG. 3B, when the user authentication method is the face recognition method, an area 330 for displaying a face image received from the camera may be included in the lock screen.

Also, a graphic object related to a previously stored face movement may be included in the lock screen. The graphic object related to the previously stored face movement may be a graphic object for inducing a user's face movement so as to release the locking state.

More specifically, the graphic object related to the previously stored face movement may be one of a graphic object for inducing a change in the shape of a user's mouth and a graphic object for inducing a change in the user's sight.

For example, as shown in the first drawing of FIG. 3B, when the user authentication method is the face recognition method, a guide information 340 for guiding a method of releasing the lock state, and a graphic object (“Hello”) related to a previously stored face movement may be further included in the lock screen.

Meanwhile, a visual appearance of the graphic object related to the previously stored face movement, such as a display position, a moving speed or a display shape, may be changed whenever the mobile terminal enters into the locking state (or whenever the user authentication function is performed). More specifically, at least one of the display position, moving speed, and the display shape of the graphic object related to the previously stored face movement may be changed in a random manner (or at random).

For example, when the mobile terminal enters into the locking state, the mobile terminal 180 may release the locking state after the graphic object related to the previously stored face movement is displayed at a first position. After that, when the mobile terminal again enters into the locking state, the controller 180 may display the graphic object related to the previously stored face movement at a second position different from the first position.

Thus, the user is to perform a user authentication through a new face movement whenever the user authentication is performed. Accordingly, it is possible to prevent the use of fake faces.

In the state in which the lock screen is displayed, the mobile terminal according to the exemplary embodiment may photograph a face image through the camera (S220).

If the lock screen is displayed on the display unit 151 when the user authentication method is set as the face recognition method, the controller 180 may recognize a user face through a camera 121.

The camera 121 may be disposed at the front of the display unit 151 to photograph the user positioned at the front of the display unit 151. For example, as shown in the first drawing of FIG. 3B, the camera 121 may be disposed at the front of the display unit 151, so that the photographing direction of the camera 121 is set to photograph the user located at the front of the display unit 151.

At least one camera 121 may be provided. In this case, the controller 180 may photograph at least one image through the at least one camera 121. Also, the controller 180 may perform the face recognition based on at least one image. Meanwhile, in the following description, it is illustrated that a single camera is used. However, the present disclosure is not limited thereto, and may be applied to when a plurality of cameras are used.

When the display unit 151 of the mobile terminal is in an on state, the camera 121 may be activated automatically or based on a user's request. Here, the activation of the camera may mean that an image of a subject can be acquired through an image sensor of the camera 121. On the contrary, the non-activation of the camera may mean that any image of the subject is not acquired through the image sensor of the camera 121.

As an example, the camera 121 may be activated based on a control command for turning on the display unit 151. As another example, the camera 121 may be activated in response to that a face recognition request is received from the user.

Alternatively, the camera 121 may be activated when an image photographing function is executed. The image photographing function may mean a function of storing an image received through the camera 121 (see FIG. 1A) in the memory 170 (see FIG. 1A). Here, an operation of the mobile terminal, in which an image received through the camera 121 is stored in the memory 170, may be expressed as ‘photographing of image,’ ‘capturing of image,’ ‘performing of image photographing operation,’ etc. The present disclosure is not limited to the expressions listed above, and various expressions having the meaning that an image received through the camera 121 is stored in the memory 170 may be freely used.

The execution of the image photographing function may mean that an application driven to photograph an image is executed. When the image photographing function is executed, the controller 180 may activate the camera 121 to be ready for photographing an image.

The image photographing function may be executed based on that an icon (or an icon of an application) related to the image photographing function is selected (or touched). When the image photographing function is performed based on that an icon is selected, the display unit 151 may be in the on state. Meanwhile, the image photographing function may be executed when at least one of keys (e.g., at least one of hardware keys and software keys) provided in the mobile terminal is selected, in addition to the method of selecting the icon related to the image photographing function. In this case, although the display unit 151 is in an off state, the controller 180 may execute the image photographing function, corresponding to that a key provided in the mobile terminal is selected.

The mobile terminal according to the exemplary embodiment may perform an image photographing operation, based on a user's selection, and the user's selection may be expressed as a ‘user's control command,’ ‘control command,’ or ‘user's request.’ Meanwhile, user's selection may be made in various manners. For example, the user may touch or press hardware keys provided in the mobile terminal or touch software keys or visual keys output on the display unit 151 (see FIG. 1A), thereby performing the image photographing operation. That is, when hardware keys related to the image photographing function are touched or pressed or when software keys or visual keys output on the display unit 151 are touched, the controller 180 (see FIG. 1A) of the mobile terminal 100 may decide that a user's control command for performing the image photographing operation has been received.

The present disclosure is not limited thereto, and the mobile terminal 100 according to the exemplary embodiment may photograph an image, based on that a user control command is received in various manners. For example, in a state in which an image received (input) through the camera 121 is output on the display unit 151, the controller 180 may photograph the image, based on that a predetermined touch is applied to the image or the display unit 151.

The predetermined touch is a touch related to the image photographing operation, and may include various touches. For example, the predetermined touch may include various touches such as a short (or tap) touch, a continuous touch where at least two short touches are applied within a reference time, a multi touch, a drag touch, a flick touch, a pinch-in touch, a pinch-out touch, a swipe touch, and a hovering touch.

Based on that a graphic object (or an image corresponding to a subject) included in the image satisfies a predetermined condition, the mobile terminal 100 according to the exemplary embodiment may photograph the image (or the graphic object). For example, when it is decided that the graphic object included in the image is identical (or similar) by a critical value or more to the previously stored graphic object, the controller 180 may photograph the image (or the graphic object).

The image received (or input) through the camera 121 may be referred to as a preview image, and refers to an image received in real time through the camera 121. That is, the image (or screen information included in the image) received through the camera 121 may be changed based on that the mobile terminal 100 is moved by an external force, that objects (or subjects) existing within a viewing angle of the camera 121 move, etc.

The image (or preview image) may be stored in the form of any one of a still image or moving image in the memory 170.

The controller 180 may display, on the display unit, an image input through the camera 121. For example, as shown in the first drawing of FIG. 3B, the controller 180 may display an image input through the camera 121 on the area 330 for displaying the image input through the camera 121.

Steps S210 and S220 may be sequentially performed, but simultaneously performed. Alternatively, the order of steps S210 and S220 may be changed.

If a face image is input, the mobile terminal according to the exemplary embodiment may change the locking state to the unlocking state, when a face movement extracted from the input face image corresponds to the previously stored face movement (S230).

If a face image is input, the controller 180 may extract a face movement from the input face image. The face movement may include movements of eyes, a nose, a mouth, and ears, which are included in a user's face. For example, the face movement may become a shape of the mouth, a direction of the user's sight, a moving speed of the user's sight, a moving pattern of the user's sight, a movement of the user's sight, etc.

In order to extract the face movement, the controller 180 may photograph, in real time, a face image through the camera 121. Also, the controller 180 may separately extract areas including the eyes, the nose, and the ears from the input face image. After that, the controller 180 may extract a face movement from the separately extracted areas.

More specifically, the controller 180 may receive at least two image frames input from the camera 121, and compare the at least two image frames, thereby extracting a face movement. The image frame may mean image data forming an image of a subject, input from the camera 121. That is, the face image may be formed with at least two image frames.

If the face movement is extracted, the controller 180 may decide whether the extracted face movement corresponds to a previously stored face movement. The previously stored face movement may be a face movement matched to a graphic object displayed on the display unit 151.

A specific graphic object matched to a specific face movement may be stored in the memory 170 of the mobile terminal according to the exemplary embodiment. For example, a movement of the shape of the mouth performing a pronunciation called “Hello” is matched to a graphic object representing a phrase called “Hello,” and a movement of the user's sight forming a specific pattern, matched to a star-shaped graphic object moving while forming a specific pattern may be stored in the memory 170.

When it is decided that the extracted face movement corresponds to the previously stored face movement, the controller 180 may change the locking state to the unlocking state.

If the locking state is changed to the unlocking state, the controller 180 may display an idle screen on the display unit 151. The idle screen is a screen indicating the unlocking state, and may be a screen including an icon or widget indicating at least one function among functions installed in the mobile terminal. The icon or widget may be a graphic object related to function installed in the mobile terminal.

The idle screen may be understood as the term “background screen,” “home screen page,” “a menu screen,” etc.

For example, as shown in a second drawing of FIG. 3B, when the extracted face movement corresponds to the previously stored face movement, the controller 180 a background screen 350 on the display unit 151.

Although not shown in this figure, when the locking state of the mobile terminal, in which a specific function of an application is limited, is changed to the unlocking state, the controller 180 may display an execution screen of the specific function on the display unit 151.

On the contrary, when it is decided that the extracted face movement does not correspond to the previously stored face movement, the controller 180 may not release the locking state. That is, the controller 180 may maintain the locking state.

The case where the extracted face movement does not correspond to the previously stored face movement as described above may be any one of a case where the user's face image corresponds to a fake face and a case where the extracted face movement is another movement. The fake face may mean a face picture, a mask copied from a face shape, etc. That is, in the present disclosure, a user authentication is performed through a face movement, so that it is possible to determine whether the user's face image corresponds to a fake face while performing a face recognition.

As such, when the extracted face movement does not correspond to the previously stored face movement, the controller 180 may decide that a user authentication has failed.

When the user authentication has failed, the controller 180 may output notification information for notifying that the user authentication has failed. The notification information may be output by at least one of visual, auditory, and tactile methods. For example, as shown in first and second drawings of FIG. 3C, when the user authentication fails, the controller 180 may display, on the display unit 151, notification information 360 called “Your login has failed. Please, read it again.”

Also, when the user authentication has failed, the controller 180 may attempt a re-authentication or perform an alternative authentication. The re-authentication may mean that a user authentication using the same method where user authentication has failed is again performed, and the alternative authentication may mean that a user authentication using a method different from the method where the user authentication has failed is performed.

Meanwhile, when a user's face image does not correspond to a previously stored face even though the user's face movement corresponds to the previously stored movement, the controller 180 may not release the locking state. That is, when the user's face movement corresponds to the previously stored face movement, and simultaneously, the user's face image corresponds to the previously stored face, the controller 180 may release the locking state.

In the above, the control method of performing a user authentication through a face recognition has been described. Accordingly, the user authentication is performed through a face movement, so that it is possible to detect whether the user's face image corresponds to a fake face while performing the user authentication.

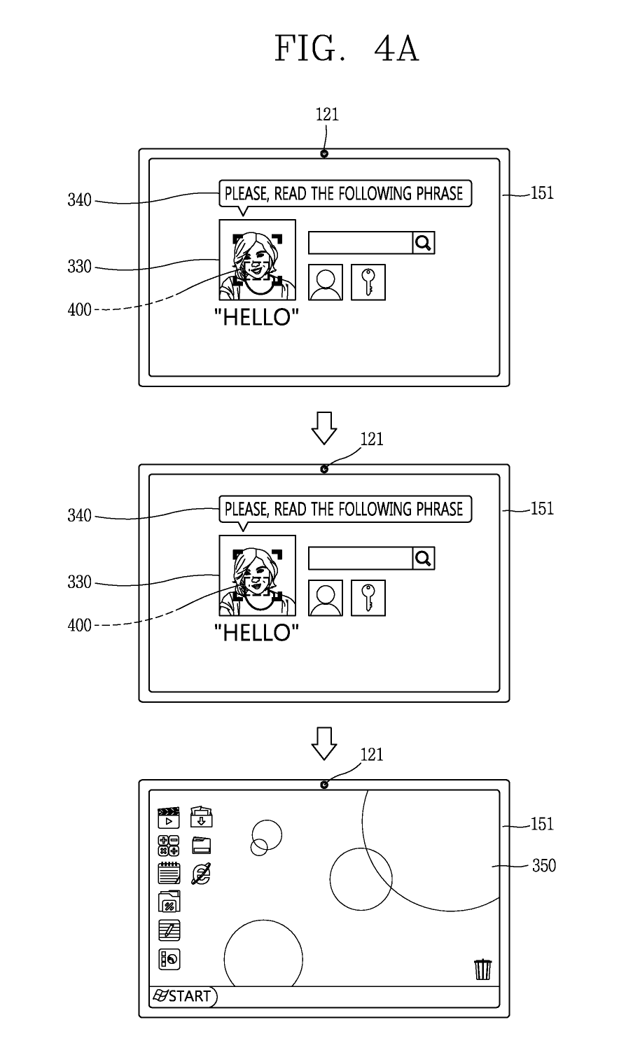

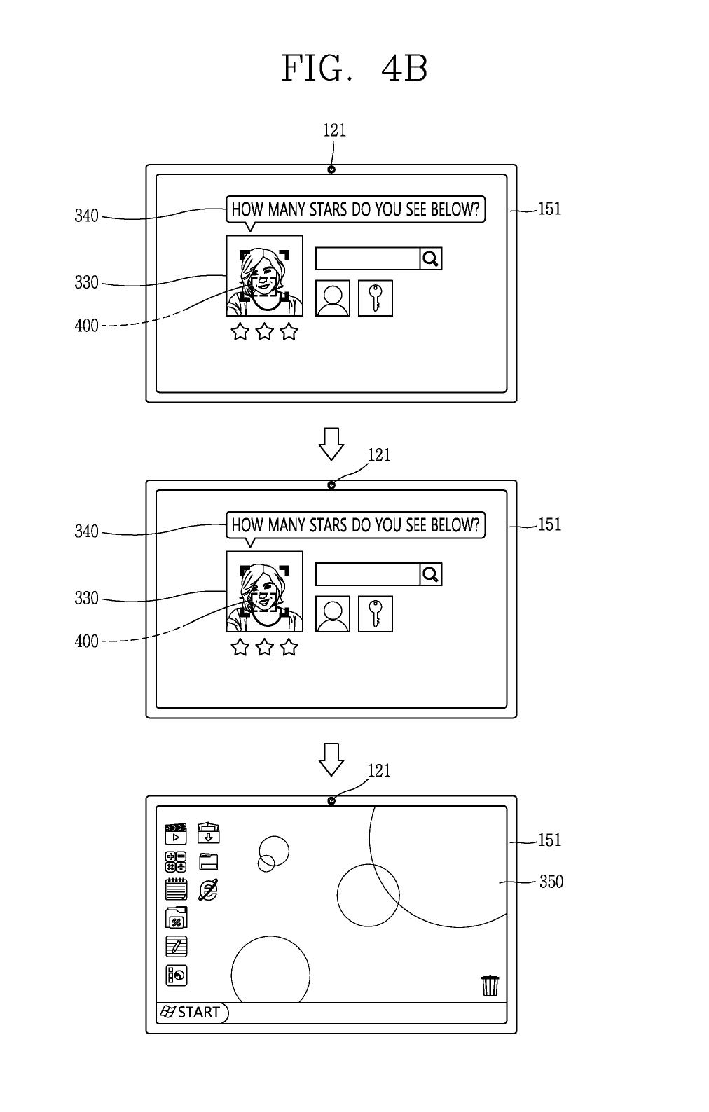

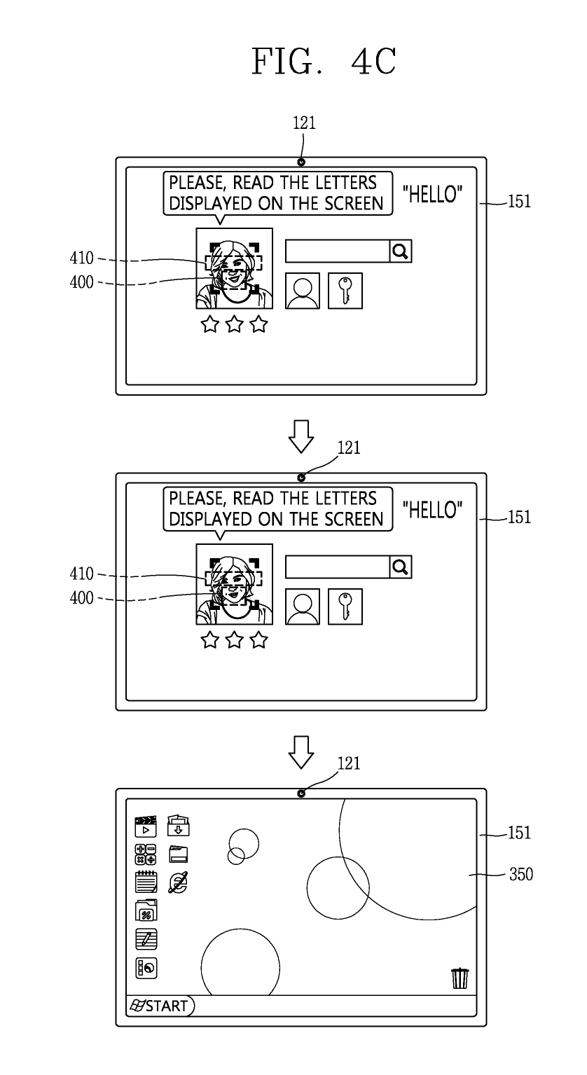

Hereinafter, a control method of performing a user authentication through a face movement will be described. FIGS. 4A to 7 are conceptual views illustrating a control method of performing a user authentication through a face movement.

When the mobile terminal is in the locking state, the controller 180 may change the locking state of the mobile terminal to the unlocking state by performing a user authentication through a face movement.

More specifically, when the mobile terminal is in the locking state, the controller 180 may display, on the display unit 151, a lock screen indicating the locking state. After that, when the locking state is released through a user authentication, the controller 180 may display a waiting screen the unlocking state.

In this case, screen information for performing a user authentication method may be included in the lock screen. For example, a graphic object and guide information for guiding a previously stored face movement may be displayed on the lock screen.

The user authentication method is a method of deciding whether at least one of a movement of a user's mouth and a movement of a user's sight corresponds to the previously stored face movement.

The movement of the user's mouth means a change in the user's mouth shape, and may be a change in the user's mouth shape for pronouncing a phrase displayed on the display unit 151 or a change in the user's mouth shape for pronouncing a phrase matched to the phrase displayed on the display unit 151.

As an example, as shown in a first drawing of FIG. 4A, the controller 180 may display a phrase called “Hello” on the display unit 151. In this case, the controller 180 may detect an area 400 in which a user's mouth is displayed in a face image 330 input from the camera 121.

More specifically, as shown in the first drawing and a second drawing of FIG. 4A, the controller 180 may detect at least two image frames including the area 400 in which the user's mouth is displayed, and may extract a movement of the user's mouth, based on the at least two image frames.

When the extracted movement of the user's mouth corresponds to the previously stored face movement, the controller 180 may the locking state of the mobile terminal to the unlocking state. For example, when the extracted movement of the user's mouth corresponds to a movement for pronouncing the phrase called “Hello,” the controller 180 may change the locking state to the unlocking state. In this case, as shown in a third drawing of FIG. 4C, a background screen 350 indicating the unlocking state may be displayed on the display unit 151.

As another example, as shown in a first drawing of FIG. 4B, the controller 180 may display, on the display unit 151, a phrase 340 called “How many stars do you see below?” In this case, the controller 180 may detect an area 400 in which a user's mouth is displayed in a face image 330 input from the camera 121.

More specifically, as shown in the first drawing and a second drawing of FIG. 4B, the controller 180 may detect at least two image frames including the area 400 in which the moth is displayed, and extract a movement of the user's mouth, based on the at least two image frames.

When the movement of the user's mouth corresponds to the previously stored face movement, the controller 180 may change the locking state of the mobile terminal to the unlocking state. For example, when the extracted movement of the user's mouth is a movement for pronouncing a phrase called “three” matched to the phrase called “How many stars do you see below?,” the controller 180 may change the locking state to the unlocking state. In this case, as shown a third drawing of FIG. 4B, a background screen 350 indicating the unlocking state may be displayed on the display unit 151.

Also, the controller 180 may perform a user authentication, based on the movement of the user's mouth and a movement of a user's sight. In this case, the controller 180 may display, in a specific area on the display unit 151, a graphic object related to the previously stored face movement to induce both the movement of the user's mouth and the movement of the user's sight. That is, the controller 180 may decide whether the direction of the user's sight facing a graphic object displayed in an arbitrary area faces a specific area and whether the movement of the user's mouth corresponds to a movement for pronouncing a specific phrase.

The specific area may be changed in a random manner (or at random) whenever the mobile terminal enters into the locking state. That is, the controller 180 may perform a user authentication, based on different face movements whenever the mobile terminal enters into the locking state. Thus, in the present disclosure, a user authentication is performed through a new face movement whenever the user authentication is performed, so that it is possible to prevent a user authentication from being performed through a fake face.

For example, as shown in a first drawing of FIG. 4C, the controller 180 may display in a specific area on the display unit 151, a phrase called “Hello” as a graphic object related to the previously stored face image.

After that, as shown in the first drawing and a second drawing of FIG. 4C, the controller 180 may detect, in a user's face image, an area 410 in which user's eyes are displayed and an image 400 in which a user's mouth is displayed. In addition, the controller 180 may detect at least two image frames including the area 410 in which the user's eyes are displayed and the area 400 in which the user's mouth is displayed, and extract a movement of the user's mouth and a movement of a user's sight, based on the at least two image frames.

When the direction of the user's sight faces a specific area in which the phrase called “Hello” is displayed, and the movement of the user's mouth corresponds to a user's mouth shape for pronouncing the phrase called “Hello,” the controller 180 may change the locking state of the mobile terminal to the unlocking state. As shown in a third drawing of FIG. 4C, if the locking state of the mobile terminal is changed to the unlocking state, the controller 180 may display a background screen 350 on the display unit 151.

In the above, the control method of performing a user authentication, based on a movement of the user's mouth, has been described.

Hereinafter, a control method of performing a user authentication, based on a movement of user's eyes, will be described.

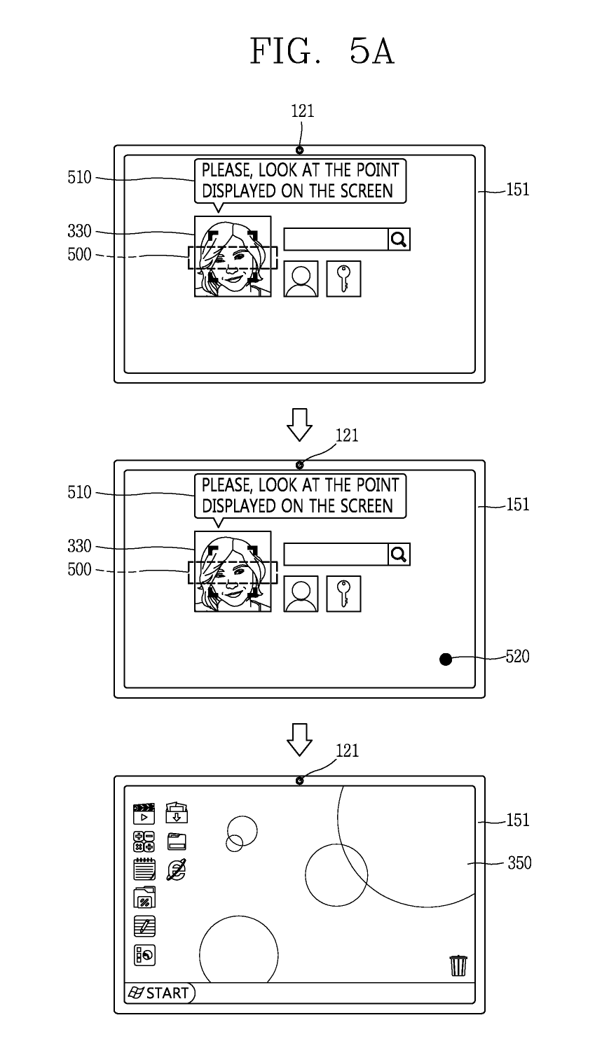

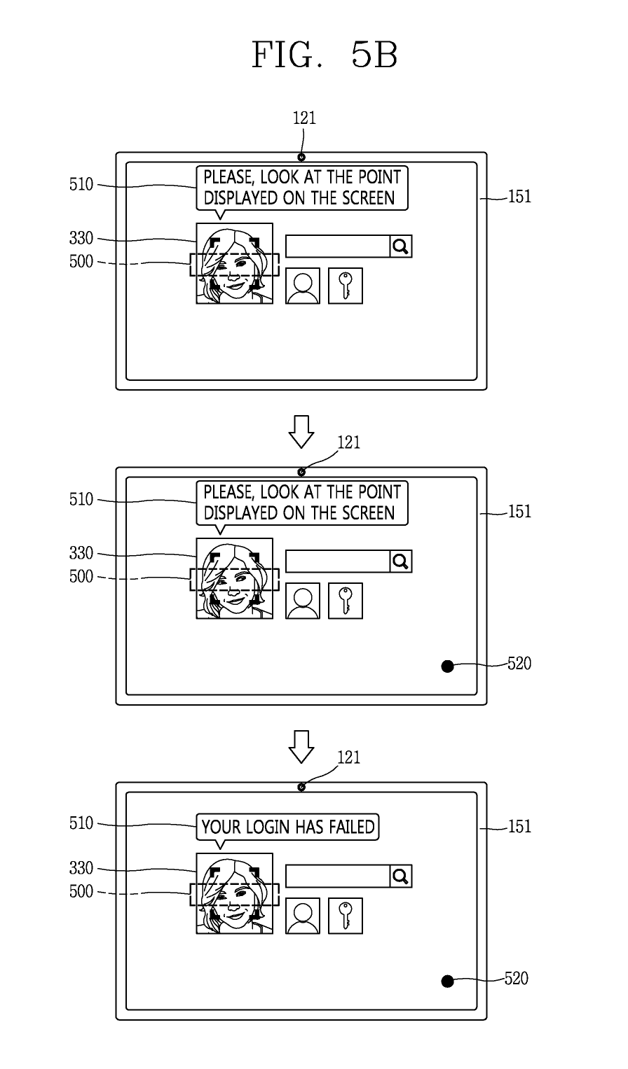

The controller 180 may perform a user authentication, based on a movement of the user's eyes. To this end, the controller 180 may display, on a lock screen, a graphic object related to the movement of the user's eyes so as to induce the movement of the user's eyes. For example, as shown in a second drawing of FIG. 5A, the controller 180 may display a specific image object 520 and guide information 510 in an arbitrary area on the lock screen.

In this case, the controller 180 may detect a moving speed of a user's sight and a sight direction from a user's face image. The moving speed of the user's sight may be a time for which the user's sight faces a specific image after the specific image is displayed. The moving speed of the user's sight may be understood as a time for which a conditioned reflex behavior of the user's sight is conducted. The sight direction may be a direction in which the user's sight faces.

For example, as shown in a first drawing and the second drawing of FIG. 5A, the controller 180 may detect an area 500 in which the user's eyes are displayed in a face image, and detect a moving speed of the user's eyes and a sight direction, based on the detected area 500.

When the moving speed of the user's sight is equal to or greater than a predetermined speed, and the sight direction faces a specific area in which a specific image object 520 is displayed, the controller 180 may change the locking state of the mobile terminal to the unlocking state. In this case, the controller 180 may display, on the display unit 151, a background screen 350 indicating the unlocking state.

On the contrary, when the moving speed of the user's sight is less than the predetermined speed, the controller 180 may not change the locking state to the unlocking state. For example, as shown in first and second drawings of FIG. 5B, when the moving speed of the user's sight is less than the predetermined speed, the controller 180 may decide that the user's face image corresponds to a fake face, thereby maintaining the locking state. In this case, as shown in a third drawing of FIG. 5B, the controller 180 may display, on the lock screen, notification information 510 called “Your login has failed”, which represents that the change from the locking state to the unlocking state has failed.

That is, in the present disclosure, it is possible to detect whether the user's face image corresponds to the fake face, based on the moving speed of the user's eyes.

Meanwhile, in the above, the control method of detecting a moving speed of the user's sight has been described. However, it may be detected that the user's sight faces the specific image object 520 within a predetermined time from a point of time when the specific image object 520 is displayed. In this case, the control method of FIGS. 5A and 5B may be identically applied.

The controller 180 may perform a user authentication, based on a movement of the user's sight. To this end, when the mobile terminal enters into the locking state, the controller 180 may display, on a lock screen, a graphic object 620 moving while forming a predetermined pattern so as to induce the movement of the user's sight.

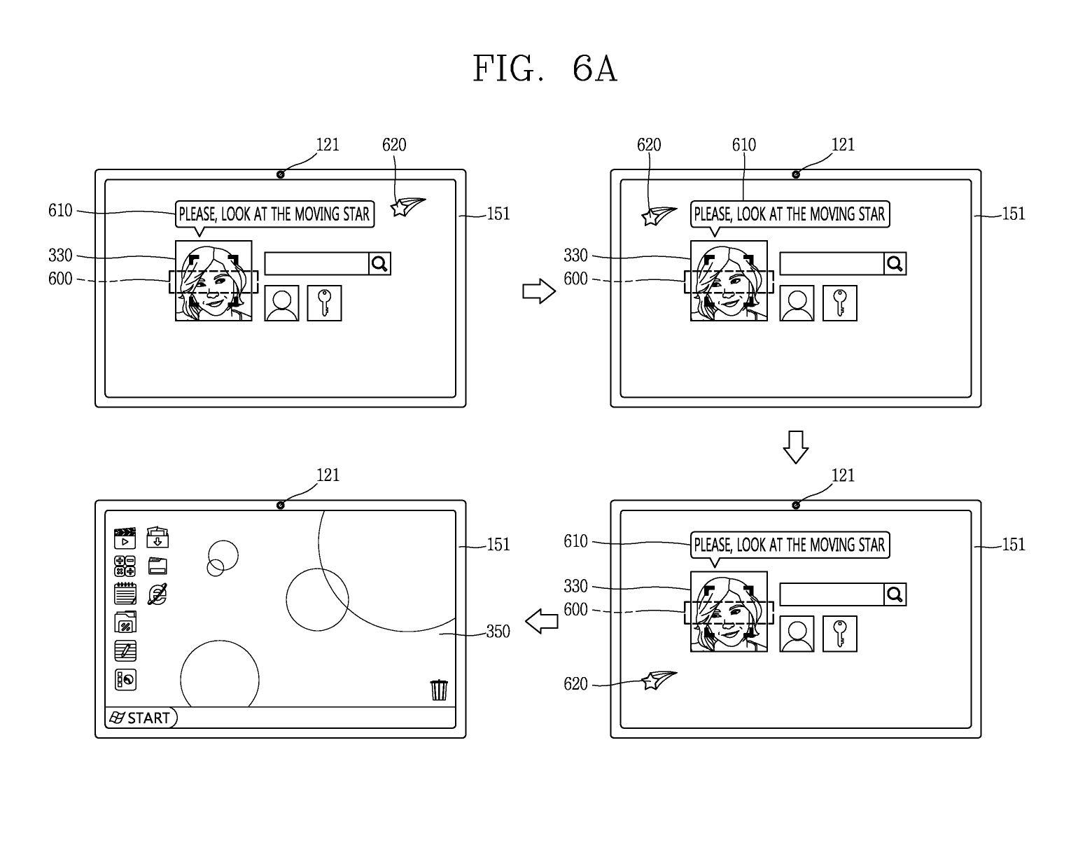

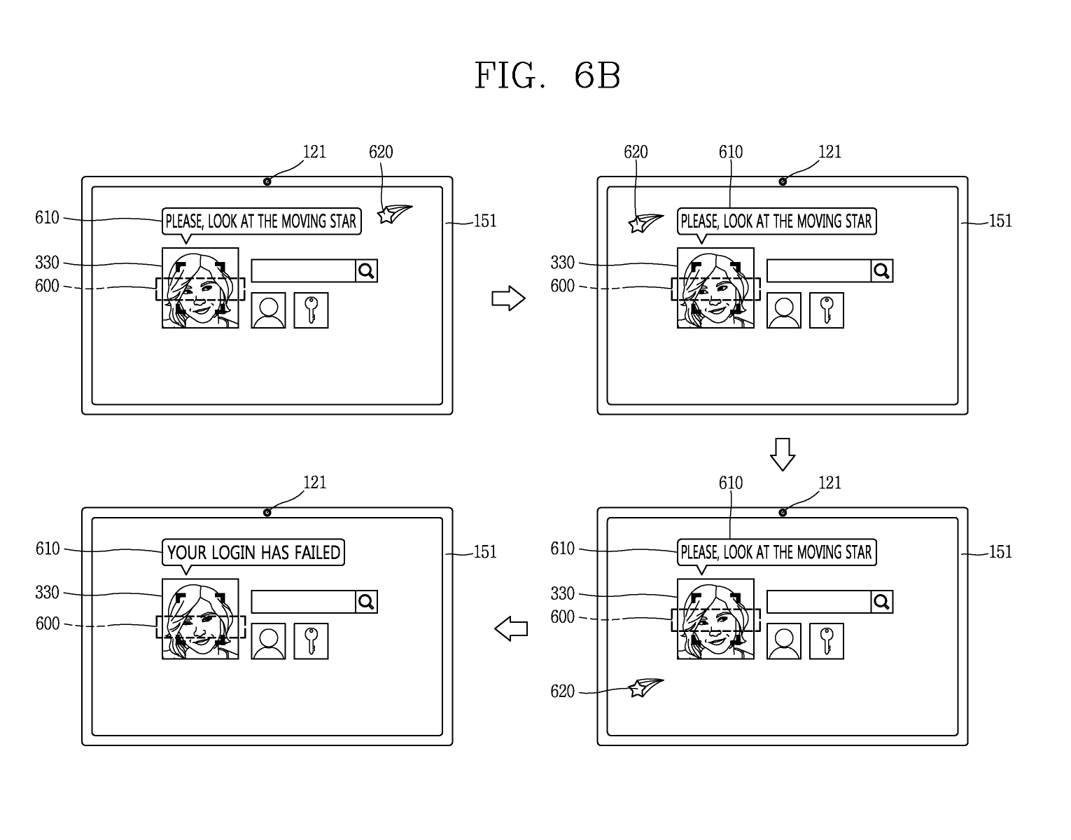

For example, as shown in first, second, and third drawings of FIG. 6A, a star-shaped graphic object 620 moving while forming a predetermined pattern and guide information 610 may be displayed on the lock screen.

The controller 180 may detect an area 600 in which user's eyes are displayed in a user's face image in the state in which the graphic object moving while forming the predetermined pattern is displayed. After that, the controller 180 may sense a sight movement from the area 600 in which the user's eyes are displayed.

Also, the controller 180 may decide whether the sensed sight movement forms a predetermined pattern formed by the graphic object 620.

When the sensed sight movement forms the predetermined pattern formed by the graphic object 620, the controller 180 may change the locking state of the mobile terminal to the unlocking state. In this case, as shown in a fourth drawing of FIG. 6A, a background screen 350 representing the unlocking state may be displayed on the display unit 151.

Meanwhile, the controller 180 may decide whether the predetermined pattern formed by the moving graphic object 620 corresponds to a predetermined pattern formed as the user's eyes move. However, the controller 180 may also decide whether the user's sight faces the moving graphic object 620. When it is decided that the user's sight faces the moving graphic object, the same control method as FIGS. 6A and 6B may be applied.

Meanwhile, when the user authentication fails, the controller 180 may output a graphic object for an alternative authentication and a graphic object for a re-authentication.

The alternative authentication may be an authentication performed through another user authentication method except a currently set authentication method. For example, the alternative authentication may include a password authentication, a fingerprint authentication, an iris authentication, a pattern authentication, and the like. Therefore, when the currently set user authentication fails, the user may release the locking state through another user authentication method. Here, a predetermined user authentication method may be used as the user authentication method for the alternative authentication.

The re-authentication may be an authentication performed through the currently set user authentication. That is, the user may again perform the user authentication by attempting the re-authentication.

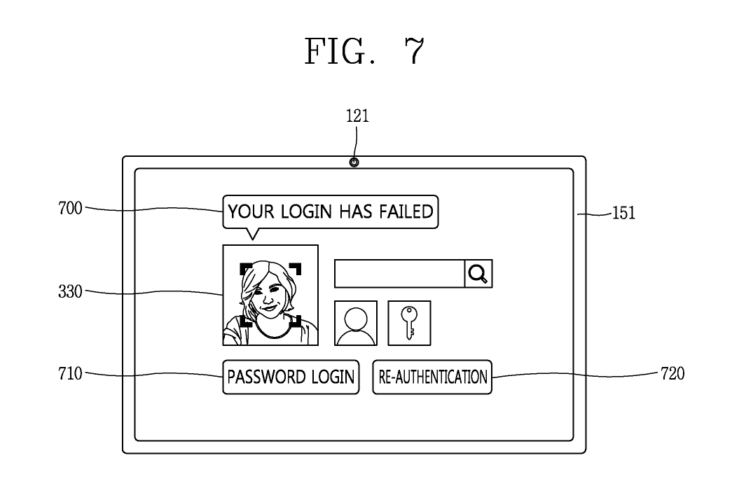

For example, as shown in FIG. 7, when the user authentication fails, the controller 180 may display, on a lock screen, a graphic object 710 related to a password login and a graphic object 720 related to the performance of a re-authentication.

Therefore, when the user authentication fails through a face recognition, the user may again attempt the user authentication through the alternative authentication or the re-authentication.

According to the present disclosure, when a user authentication is performed through a user's face image, it is possible to detect whether the user's face image corresponds to a fake face. Accordingly, it is possible to detect whether the user's face image corresponds to a fake face through the user's face movement, thereby improving the security of the user authentication.

Also, according to the present disclosure, it is possible to detect whether the user's face image corresponds to a fake face through a user's mouth shape corresponding to a graphic object arbitrarily displayed on the display unit and a movement of the user's sight in the user's face image. Accordingly, the user can perform a user authentication without showing a sad look for the user authentication.

Also, according to the present disclosure, since it is detected whether the user's face image corresponds to a fake face through a movement of the user's face image, it is possible to simultaneously detect whether the user authentication has been performed and whether the user's face image corresponds to a fake face. That is, it is possible to integrate, as a user authentication process through a face image and a fake face detection process for detecting whether the face image corresponds to a fake face.

Various embodiments may be implemented using a machine-readable medium having instructions stored thereon for execution by a processor to perform various methods presented herein. Examples of possible machine-readable mediums include HDD (Hard Disk Drive), SSD (Solid State Disk), SDD (Silicon Disk Drive), ROM, RAM, CD-ROM, a magnetic tape, a floppy disk, an optical data storage device, the other types of storage mediums presented herein, and combinations thereof. If desired, the machine-readable medium may be realized in the form of a carrier wave (for example, a transmission over the Internet). The processor may include the controller 180 of the mobile terminal.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A mobile terminal capable of performing a face recognition function, the mobile terminal comprising:
a display unit;
a camera configured to photograph a face image; and
a controller configured to change a locking state in which the execution of a function of the mobile terminal is limited to an unlocking state in which the execution of the function of the mobile is possible, based on that a face movement extracted from the face image photographed through the camera satisfies a predetermined condition,
wherein the controller displays, on the display unit, a graphic object related to a previously stored face movement, and
wherein, when the face movement extracted from the face image photographed through the camera corresponds to the previously stored face movement, the controller changes the locking state to the unlocking state.

2. The mobile terminal of claim 1, wherein the face movement extracted from the photographed face image is at least one of a movement of a sight and a movement of a mouth.

3. The mobile terminal of claim 2, wherein the movement of the sight is a movement based on at least one of a moving speed of the sight and a sight direction.

4. The mobile terminal of claim 1, wherein, when the extracted face movement does not correspond to the previously stored face movement, the controller decides that the face image corresponds to a fake face.

5. The mobile terminal of claim 1, wherein the graphic object related to the previously stored face movement is a specific word, and
wherein the controller detects a movement of the mouth in the photographed face image, and changes the locking state to the unlocking state, when the extracted movement of the mouth is a movement of the mouth corresponding to the specific word.

6. The mobile terminal of claim 5, wherein the specific word is displayed at a specific position on the display unit, and
wherein the controller detects a sight direction in the photographed face image, and changes the locking state to the unlocking state, when the sight faces a specific area in which the specific word is displayed, based on the sight direction.

7. The mobile terminal of claim 6, wherein, when the at least one of the movement of the sight and the movement of the mouth does not correspond to a predetermined movement, the controller maintains the locking state.

8. The mobile terminal of claim 6, wherein the controller arbitrarily sets the specific position at which the specific word is displayed.

9. The mobile terminal of claim 1, wherein, when the sight extracted from the photographed face image moves to face the graphic object within a predetermined time from a point of time when the graphic object is displayed, the controller changes the locking state to the unlocking state.

10. The mobile terminal of claim 1, wherein the graphic object related to the previously stored face movement is a graphic object moving while forming a predetermined pattern, and
wherein the controller detects a movement of the sight in the photographed face image, and changes the locking state to the unlocking state, when a pattern formed based on the movement of the sight corresponds to the predetermined pattern.

11. The mobile terminal of claim 10, wherein, when the pattern formed by the movement of the sight does not correspond to the predetermined pattern, the controller maintains the locking state.

12. The mobile terminal of claim 1, wherein, when the movement of the photographed face image does not satisfy the predetermined condition, the controller maintains the locking state, and displays, on the display unit, notification information for notifying that the locking state is not released.

13. The mobile terminal of claim 1, wherein, when the mobile terminal is in the locking state, the controller displays, on the display unit, a lock screen indicating the locking state, and
wherein the graphic object related to the previously stored face movement is displayed on the lock screen.

14. The mobile terminal of claim 13, wherein, when the lock screen is displayed, the controller arbitrarily sets the position at which the graphic object related to the previously stored face movement is displayed on the lock screen.

15. The mobile terminal of claim 1, wherein, when the photographed face image does not correspond to a previously stored face image, the controller maintains the locking state even though a face movement extracted from the previously stored face image corresponds to the previously stored face movement.

16. A method for controlling a mobile terminal capable of performing a face recognition function, the method comprising:
displaying, on a display unit, a graphic object related to a previously stored face movement;
photographing a face image through a camera;
deciding whether a face movement extracted from the photographed face image corresponds to the previously stored face movement; and
when it is decided that the photographed face image corresponds to the previously stored face movement, changing a locking state in which the execution of a function of the mobile terminal is limited to an unlocking state in which the execution of the function of the mobile is possible.

17. The method of claim 16, wherein the previously stored face movement is at least one of a movement of a sight included in the face image and a movement of a mouth included in the face image.

18. The method of claim 16, wherein the graphic object related to the previously stored face movement is displayed at an arbitrary position on a lock screen indicating the locking state.
